(19) United States
(12) Patent Application Publication
(10) Pub. No.: US 2019/0097355 A1
(43) Pub. Date: Mar. 28, 2019

(54) iCubeLock

(71) Applicant: Ira Sheldon Jacobson, Coral Gables, FL (US)

(72) Inventor: Ira Sheldon Jacobson, Coral Gables, FL (US)

(21) Appl. No.: 15/717,708

(22) Filed: Sep. 27, 2017

(51) Int. Cl. H01R 13/639

(52) U.S. Cl. CPC H01R 13/6395

(57) ABSTRACT

A bracket to lock cell phone chargers or other electronic chargers to an electrical outlet into which they are plugged. This is to prevent unauthorized borrowing, theft or other removal of said chargers or charging cables.

### CROSS REFERENCE TO RELATED APPLICATIONS

Provisional patent application 62/495,912 dated Sep. 29, 2016

### STATEMENT REGARDING FEDERALLY SPONSORED RESEARCH OR DEVELOPMENT

Not Applicable

### DESCRIPTION OF ATTACHED APPENDIX

Not Applicable

Sep. 25, 2017

### INTRODUCTION

The iCubeLock is a new product. It is a device to secure one or two cell phone chargers or other chargers and charging cables to the electrical outlet, thereby discouraging theft or unauthorized “borrowing” of the chargers. It mounts on the electrical outlet using the same screw holes as the outlet cover plate. The iCubeLock accommodates a wide range or variety of chargers, including those for laptop computers and cameras. It would be indispensable in a home or office with multiple occupants who are cell phone users, such as children, who are constantly losing or misplacing the chargers. Equally, in an office, work station, lunch or coffee break room, one could secure their charger and be confident that they could leave and the charger and cable will be there after leaving for other business, errands, lunch, meetings or overnight, without having to disconnect it and stuff it into pocket or handbag. It is made of non-conductive plastic.

Healthcare facilities, insurance, legal or other business offices, schools, classrooms, municipal and government offices would all find this useful.

### BRIEF SUMMARY

A device to lock cell phone chargers and accompanying cables to the electrical outlet providing power supply. This is to prevent unauthorized borrowing, theft or other removal of said chargers or charging wires.

### SPECIFICATIONS

In FIG. 1 is illustrated prior art known as ichargerlock. This device is limited to the specific charger provided and can be attached only to the older style double oval socket having one mounting screw but not to the newer Decora style socket having two mounting screws. It cannot be used to secure chargers of other shapes or dimensions to the electrical outlet. In other words, only their supplied proprietary charger can be used. In distinction to my invention, the iCubeLock, will secure a wide variety of chargers available at a multitude of retail outlets to either the older style double oval socket having one mounting screw or to the Decora style socket having two mounting screws.

In FIG. 2 is a side view of iCubeLock 1. Faceplate 3 constitutes the front of iCubeLock 1 and tab 7 is an extension of faceplate 3 and provides for storing coiled cable. Screw 4 secures mounting flange top 8 and screw 5 secures mounting flange bottom 9 of iCubeLock 1 to faceplate 2a of Decora style electric outlet as illustrated in FIG. 3. Screw 6 fastens iCubeLock 1 to the older style double oval electrical outlet having one center screw as shown in FIG. 4.

In FIGS. 5 and 6 are illustrated hole 11 in top flange 8 for passage of screw 4 and hole 12 in bottom flange 9 for passage of screw 5. Screws 4 and 5 secure iCubleLock 1 to Decora style faceplate 2a. Hole 13 is passage of screw 6 for securing iCubeLock 1 to old style double oval outlet faceplate 2b. A charging cable may be passed through opening 14 and coiled for compact storage, this cable may be either cable 21a or 21b having terminal connector 22a or 22b with a diameter smaller than that of opening 14. Opening 15 is for passage of charging cable 21a that inserts into top charger 19a. Opening 16 is for passage of charging cable 21b that inserts into lower charger 19b. Chargers 19a and 19b can be of different shapes and sizes. Electrical female receptacle 10a receive the prongs of charger 19a and receptacle 10b receives the prongs of charger 19b. Terminal connectors 22a and 22b are small enough to pass through openings 15 or 16.

In FIG. 7 is a frontal view and in FIG. 8 is a bottom view showing slit 17, which provides passage of charging cable 21c having terminal connector 18 that is too large for passing through openings 15 or 16.

iCubeCharger 1 may be produced by injection molding of a suitable plastic such as acrylic or styrene. Another method of production is by cutting a piece of plastic sheet to proper shape and heat forming it to the finished shape. Another method of production is a plastic stamping process.

The attaching screws may be the same screws 4 and 5 that attach electrical outlet faceplate cover 2a. Screw 6 must be of the length adequate to secure iCubeLock 1 though hole 13 into the center mounting hole of old style double oval electrical outlet 2b.

Installation instructions are as follows:

(1) Plug charger 19a into the electrical receptacle 10a.
(2) Pick up cable 21a and thread small connector 22a through opening 15 in the faceplate 3 of the iCubeLock 1. Terminal connector 22a connects to a cell phone or other electronic device. Starting from the inside (enclosed side) insert terminal connector 22a through opening 15 and pull cable 21a through until USB terminal 20a touches the inside of iCubeLock 1. Because the diameter of USB terminal 20a is greater than the diameter of opening 15, iCubeLock 1 captures and secures USB terminal 20a along with charging cable 21a to iCubeLock 1. The same procedure captures USB terminal 20b and charging cable 21b within iCubeLock 1 by threading small terminal connector 22b through opening 16.
(3) Remove the two screws holding the electrical outlet cover plate 2a, or the center screw for older style double oval style outlet 2b. Do not remove faceplate 2a or faceplate 2b.
4) Plug USB terminal 20a of charging cable 21a into the chargers 19a and plug charger 19a into receptacle 10a. Repeat the procedure for USB terminal 20b and charger 19b, plug charger 19b into receptacle 10b.
5) For Decora style outlet, remove screws 4 and 5 and align hole 11 of iCubeLock 1 with the top screw hole in faceplate 2a and align hole 12 of iCubeLock 1 with the bottom hole in faceplate 2a, then insert and tighten screws 4 and 5. Use screws 4 and 5 removed from faceplate 2a if long enough. If not, use longer screws. The customary screws are 6-32 SAE ½ inch long.
6) For the older style double oval sockets with single central screw fastening faceplate 2b, remove the central screw holding faceplate 2b in place, be careful not to remove faceplate 2b. Align hole 13 of iCubeLock 1 with the center screw hole in faceplate 2b, insert screw 6 through hole 13 and into said center screw hole of faceplate 2b. With iCubeLock in the vertical position, tighten screw 6 until iCubeLock 1 securely fastens to the faceplate 2b. Customary screw size is 3 inches long 6-32 SAE. Refer to drawings in FIGS. 2 through 4 to see positioning of iCubeLock 1.
7) When using charging cable 21c having large terminal connector 18, which is too large for pass through openings 15 or 16, slit 17 is available. After plugging charger 19c into receptacle 10a, insert USB terminal 20c into charger 19c. Then pass charging cable 21c, through the slit 17 of bottom flange 9, so that it threads out of the iCubeLock through the bottom as shown in FIG. 8. Use instructions in 5 and 6 above to fasten iCubeLock 1 to either faceplate 2a or 2b.
8) Tab 7 of iCubeLock 1 is used to store charging cable 21 a, b or c when coiled-up or similarly arranged. Charging cable terminal connector 22a and 22b can pass through the opening 14 in tab 7 for securing cables 21a and 21b.

### LIST OF DRAWINGS

FIG. 1 shows photograph of prior art, the ichargerlock.

FIG. 2 is a side view of iCubeLock 1 and screws for different applications.

FIG. 3 is a side view of iCubeLock 1 attached to Decora style electrical outlet faceplate 2a using two screws.

FIG. 4 is a side view of iCubeLock 1 attached to an old style double oval style electrical outlet faceplate 2b using one screw.

FIG. 5 is a frontal view of iCubeLock 1 overlying Decora style faceplate 2a.

FIG. 6 is a side view of iCubeLock 1 attached to faceplate 2a showing chargers and cables.

FIG. 7 is frontal view of iCubeLock 1 showing a charger 19c with connecting cable 21c having terminal connector 18 that is too large to pass through holes 15 or 16 so the cable is passed through slit 17 and thereby secured.

FIG. 8 a bottom view of iCubeLock 1 of cable illustrated in FIG. 7.

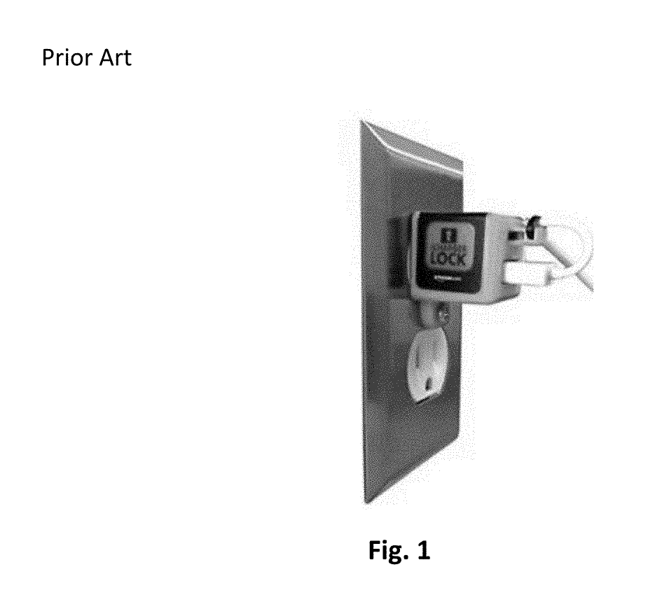

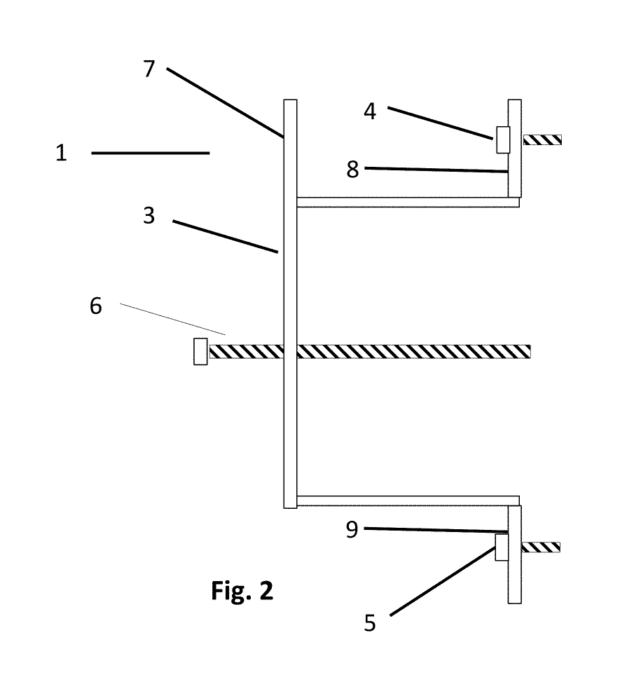

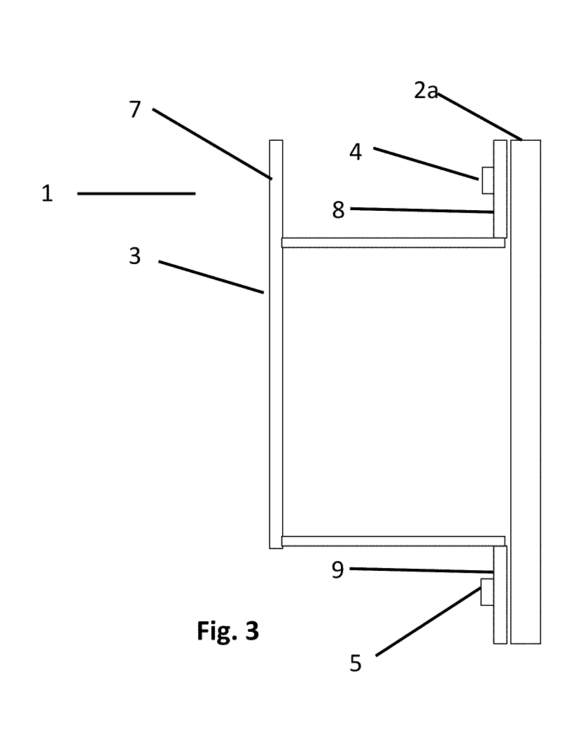

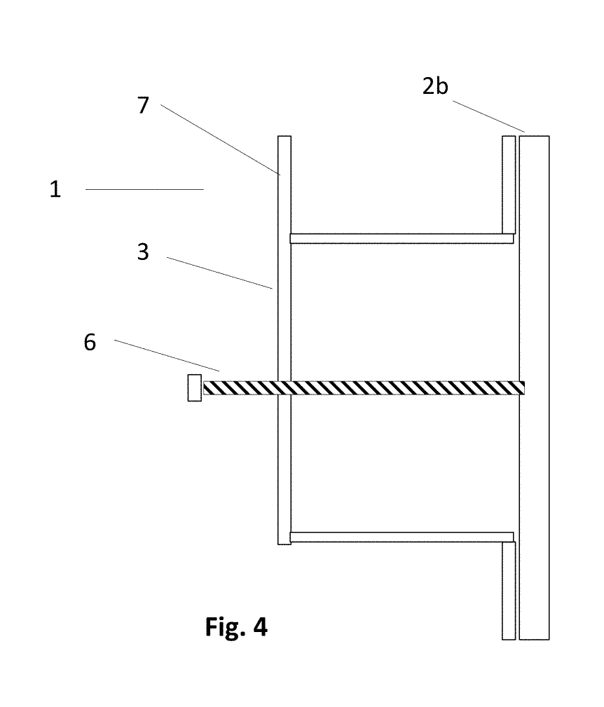

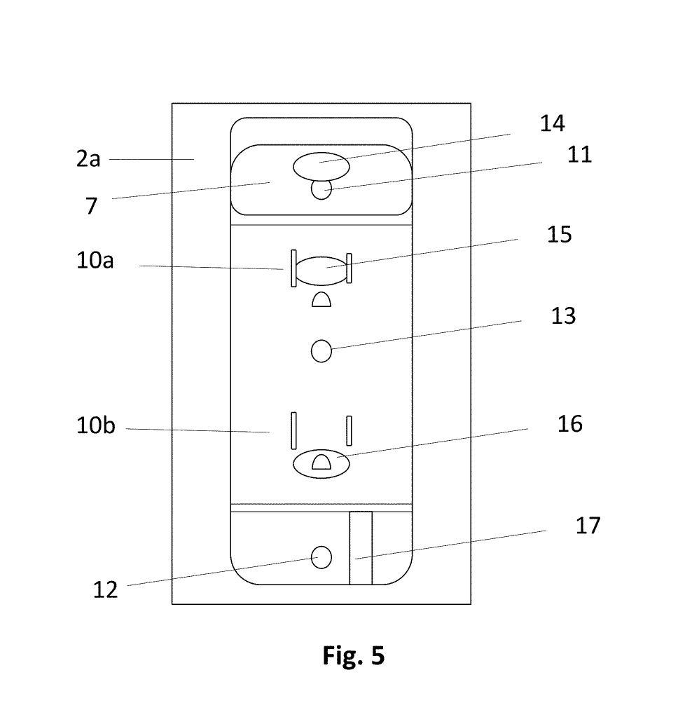

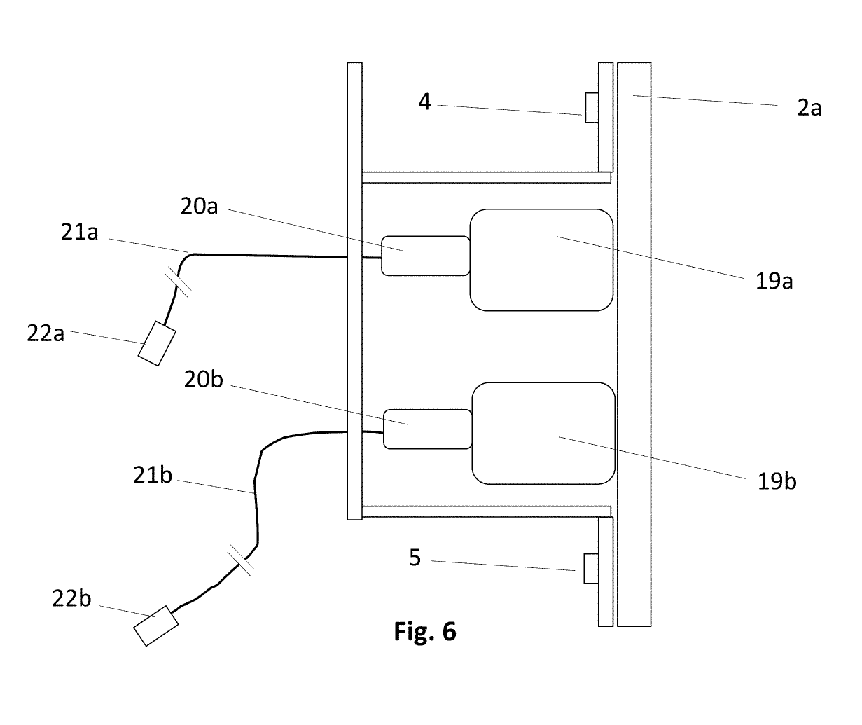

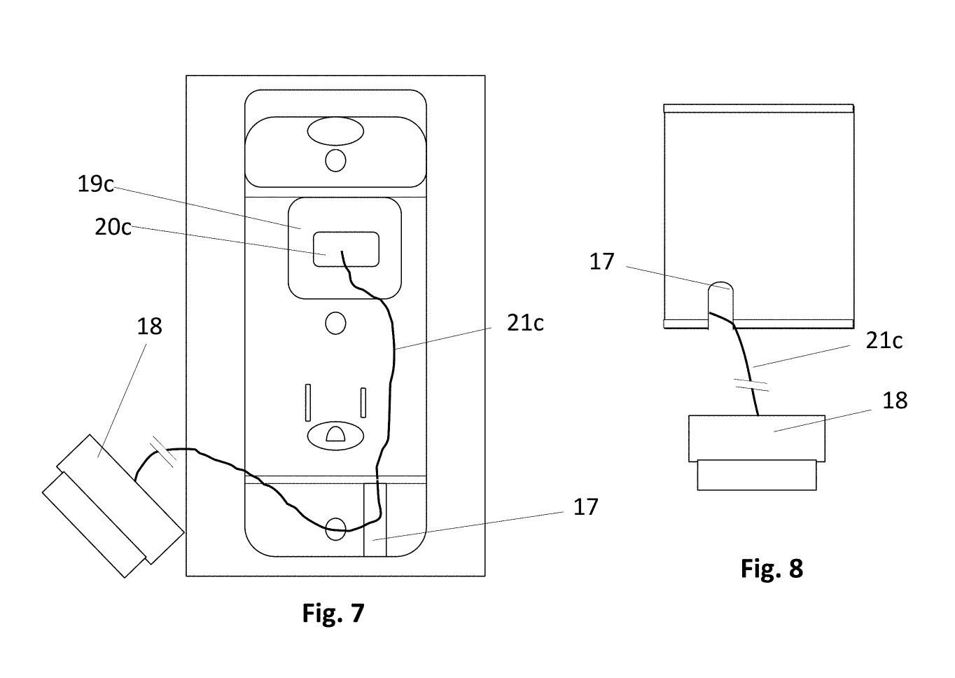

1. A device to lock and secure cell phone chargers and accompanying electrical cables to an electrical outlet power source consisting of
a. a piece of formable material such as plastic, shaped to fit over an electrical outlet faceplate and having mounting holes through which screws pass and align with mounting screw holes of said electrical outlet faceplate so as to entrap one or more chargers and charging cables and
b. having openings of suitable form and size to allow the charging cable to pass through but trap the USB terminal of the charging cable,
thereby, preventing theft or otherwise unauthorized removal of chargers or charging cables.

2. The device of claim 1 for securing other charging devices and electrical cables used to charge various electronic devices, including but not limited to laptop computers and cameras
